(19) United States
(12) Patent Application Publication
(10) Pub. No.: US 2016/0048859 A1
(43) Pub. Date: Feb. 18, 2016

(54) VENUE BOUNDARY EVALUATION FOR INFERRING USER INTENT

(71) Applicant: Microsoft Corporation, Redmond, WA (US)

(72) Inventors: Mor Doron, Shoham (IL); Daniel Avigdor, Herzliya (IL); Boaz Sapir, Herzliya (IL); Dima Stopel, Herzliya (IL)

(21) Appl. No.: 14/459,753

(22) Filed: Aug. 14, 2014

(51) Int. Cl. G06Q 30/02; H04W 4/02; H04W 4/04

(52) U.S. Cl. CPC G06Q 30/0205; H04W 4/04; H04W 4/025

(57) ABSTRACT

One or more techniques and/or systems are provided for inferring user intent and/or for inferring a user location type of a user based upon venue boundary evaluation. For example, a user is located at a current user location, such as a downtown district of a city. One or more venue evaluation boundaries, corresponding to areas around the current user location, may be defined. Potential user intents, corresponding to venue types of venues within a venue evaluation boundary, may be identified (e.g., a buy coffee intent, a go to theatre intent, a meet a friend for lunch, intent, etc.) and may be assigned user intent values (e.g., the meet a friend for lunch intent may be assigned a lower value due to a current time being 9 am). Venue evaluation boundaries may be evaluated until an inferred user intent and/or inferred user location type (e.g., commercial, residential, etc.) is identified.

### BACKGROUND

Many users may travel to various locations with their mobile devices. For example, a user may travel to a downtown district of a city. The downtown district may comprise a plethora of venues, such as clothing stores, coffee shops, banks, theatres, parks, monuments, and/or other locations of interest. The user may desire to discover and/or learn about such venues.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for inferring user intent based upon venue boundary evaluation and/or for inferring a user location type based upon venue boundary evaluation are provided herein. In an example of inferring user intent based upon venue boundary evaluation, a first venue evaluation boundary and a second venue evaluation boundary are defined based upon a current user location of a user. A first potential user intent, corresponding to a first venue type of venues located within the first venue evaluation boundary, is identified. A second potential user intent, corresponding to a second venue type of venues located within the first venue evaluation boundary, is identified. A first user intent inference value is determined for the first potential user intent based upon relevancy values of venues, of the first venue type, within the first venue evaluation boundary. A second user intent inference value is determined for the second potential user intent based upon relevancy values of venues, of the second venue type, within the first venue evaluation boundary. Responsive to a difference between the first user intent inference value and the second user intent inference value exceeding a threshold, a first identification of an inferred user intent as either the first potential user intent or the second potential user intent is performed.

Responsive to the difference between the first user intent inference value and the second user intent inference value not exceeding the threshold, a third user intent inference value for the first potential user intent is determined based upon relevancy values of venues, of the first venue type, within the second venue evaluation boundary. A fourth user intent inference value, for the second potential user intent, is determined based upon relevancy values of venues, of the second venue type, within the second venue evaluation boundary. Responsive to a difference between the third user intent inference value and the fourth user intent inference value exceeding the threshold, a second identification of the inferred user intent as either the first potential user intent or the second potential user intent is performed.

In an example of inferring a user location type based upon venue boundary evaluation, a first venue evaluation boundary and a second venue evaluation boundary are defined based upon a current user location of a user. A first potential user location type, corresponding to a first venue type of venues located within the first venue evaluation boundary, is identified. A second potential user location type, corresponding to a second venue type of venues located within the first venue evaluation boundary, is identified. A first user location type inference value, for the first potential user location type, is determined based upon relevancy values of venues, of the first venue type, within the first venue evaluation boundary. A second user location type inference value, for the second potential user location type, is determined based upon relevancy values of venues, of the second venue type, within the first venue evaluation boundary. Responsive to a difference between the first user location type inference value and the second user location type inference value exceeding a threshold, a first identification of an inferred user location type as either the first potential user location type or the second potential user location type is performed.

Responsive to the difference between the first user location type inference value and the second user location type inference value not exceeding the threshold, a third user location type inference value for the first potential user location type is determined based upon relevancy values of venues, of the first venue type, within the second venue evaluation boundary. A fourth user location type inference value, for the second potential user location type, is determined based upon relevancy values of venues, of the second venue type, within the second venue evaluation boundary. Responsive to a difference between the third user location type inference value and the fourth user location type inference value exceeding the threshold, a second identification of the inferred user location type as either the first potential user location type or the second potential user location type is performed.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of inferring user intent based upon venue boundary evaluation.

FIG. 2 is a component block diagram illustrating an exemplary system for inferring user intent based upon venue boundary evaluation, where two venue evaluation boundaries are evaluated.

FIG. 3 is a component block diagram illustrating an exemplary system for inferring user intent based upon venue boundary evaluation, where three venue evaluation boundaries are evaluated.

FIG. 4 is a flow diagram illustrating an exemplary method of inferring user location types based upon venue boundary evaluation.

FIG. 5 is a component block diagram illustrating an exemplary system for inferring user location types based upon venue boundary evaluation.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for inferring user intent based upon venue boundary evaluation and/or for inferring a user location type based upon venue boundary evaluation are provided herein. Users may desire to obtain recommendations, coupons, app suggestions, promotional alerts, and/or a variety of information about venues that may be relatively close to the user (e.g., coffee shops within walking distances, ski instruction schools within 25 miles, movie theatres within 5 miles, etc.). Accordingly, an intent inference component may infer a user intent, such as in real-time while the user is at a current user location, based upon an evaluation of venues within one or more venue evaluation boundaries of the current user location. The intent inference component may evaluate venues within venue evaluation boundaries in an efficient manner so that real-time recommendations and/or other information may be provided to the user based upon the venue evaluation. In an example, the intent inference component may be locally hosted on a client device, and thus may mitigate bandwidth utilization and/or preserve privacy of user information, such as locational information that the user has given content to use for identifying venues located near the user and/or user descriptive information that the user has given content to use to determine relevancy values of venues. In another example, the intent inference component may be hosted on a remote server, and thus may mitigate client side memory and/or processer utilization. In an example, at least some of the intent inference component may be hosted locally and at least some of the intent inference component may be hosted remotely. The user may take affirmative action, such as providing opt-in consent, to allow access to and/or use of user locational information and/or other user descriptive information (e.g., social network posts, calendar entries, past user purchasing information, a user profile, etc.), such as for the purpose of determining relevancy values of venues (e.g., where a user responds to a prompt regarding the collection and/or use of such information).

As provided herein, a user's intent and/or location type may be inferred more quickly, accurately, precisely, etc. as compared to other techniques. For example, by initially limiting the consideration of venues that may clarify the user intent and/or location type to a highly localized set (e.g., venues within the first venue evaluation boundary), such an embodiment may prioritize the consideration of a small set of nearest venues which may provide a faster clarification than considering a large set of venues. By expanding the range of considered venues (e.g., venues within the second venue evaluation boundary, etc.), such as after failing to infer the user's intent and/or location type, additional venues may be considered to infer the user's intent and/or location type, where such additional ‘telling’ venues may otherwise be ignored. In this way, a user's intent and/or location type may be more accurately inferred so that relevant information may be provided to the user quickly (e.g., in real-time, in a sorted order, etc.).

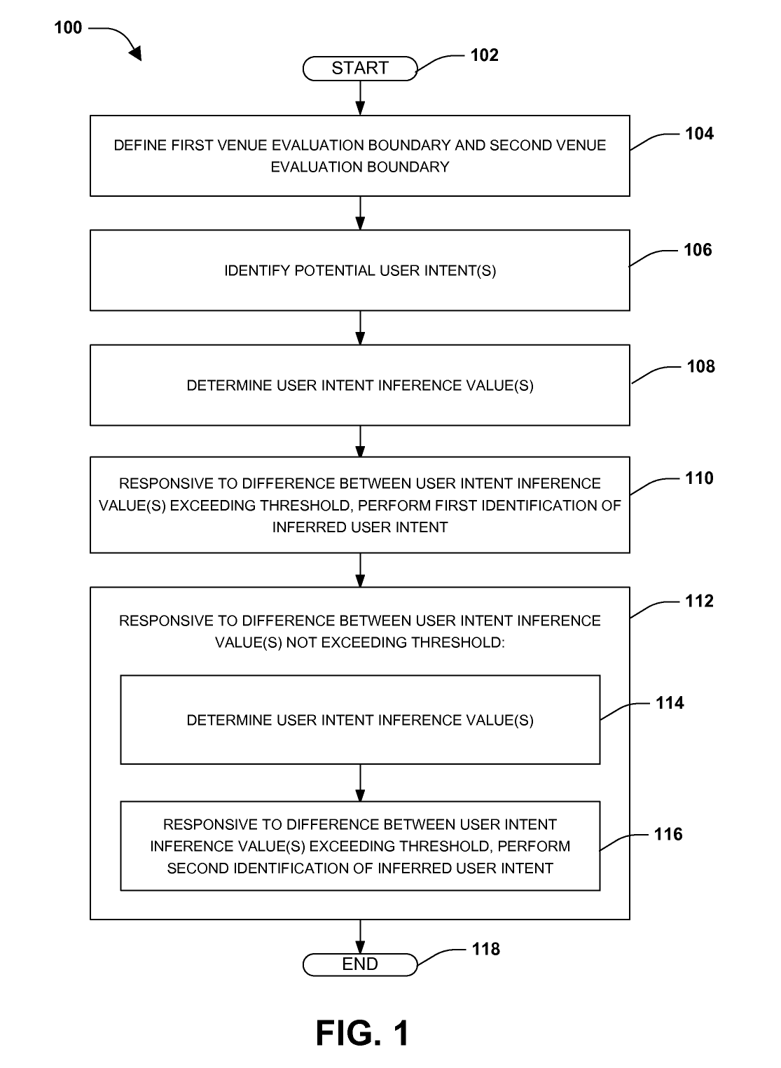

An embodiment of inferring user intent based upon venue boundary evaluation is illustrated by an exemplary method 100 of FIG. 1. At 102, the method starts. In an example, a user may be located at a current user location. For example, a mobile device, such as a GPS component of a mobile phone, may indicate that the user is within a downtown district of a city. At 104, a first venue evaluation boundary and a second venue evaluation boundary are defined based upon the current user location. For example, the first venue evaluation boundary may comprise an area within a 200 meter radius of the current user location, and the second venue evaluation boundary may comprise an area within a 600 meter radius of the current user location (e.g., which may overlap the first venue evaluation boundary). In an example, a first size of the first venue evaluation boundary and/or a second size of the second venue evaluation boundary may be specified based upon venue types within a proximity of the user (e.g., a smaller radius may be defined for pizza shop venues, whereas a larger radius may be defined for sporting arena venues because a user may be more willing to travel further for sporting events than eating pizza). It may be appreciated that a venue evaluation boundary may comprise any size and/or shape (e.g., based upon a user preference, a venue type, historical travel patterns of the user, etc.). It may be appreciated that any number of venue evaluation boundaries may be defined (e.g., venue evaluation boundaries may be defined, on the fly, based upon an evaluation of a current venue evaluation boundary not resulting in an identification of an inferred user intent, and thus a new venue evaluation boundary may be defined for further evaluation to identify the inferred user intent). In an example, a venue evaluation boundary is defined based upon venue density, such that a threshold number of venues are comprised within the venue evaluation boundary.

At 106, one or more potential user intents are identified. In an example, a first potential user intent, corresponding to a first venue type of venues located within the first venue evaluation boundary, may be identified. For example, an eat hot dogs potential user intent may be identified based upon two hot dog vender venues being located within the first venue evaluation boundary. A second potential user intent, corresponding to a second venue type of venues located within the first venue evaluation boundary, may be identified. For example, a ride bus potential user intent may be identified based upon a bus stop venue being located within the first venue evaluation boundary.

At 108, one or more user intent inference values are identified. In an example, a first user intent inference value may be determined for the first potential user intent based upon relevancy values of venues, of the first venue type, within the first venue evaluation boundary. A second user intent inference value may be determined for the second potential user intent based upon relevancy values of venues, of the second venue type, within the second venue evaluation boundary.

In an example, a relevancy value of a venue may be determined based upon a name of the venue (e.g., a well-known name of a company may be assigned a relatively higher relevancy value), a type of venue (e.g., a more obscure or unknown venue, such as a rarely visited pawn shop, may be assigned a relatively lower relevancy value), a distance between the venue and the current user location (e.g., a relatively higher relevancy value may be assigned for venues that are closer to the user), a review of the venue (e.g., a venue with high user reviews may be assigned a relatively higher relevancy value), operating hours of the venue (e.g., a relatively lower relevancy value may be assigned to a venue that is closed for the day or temporarily inoperable, such as a bus station where the next bus will not arrive for another 6 hours), and/or any other descriptive information of the venue. In another example, a relevancy value of a venue may be determined based upon a current time, a current date, a current season (e.g., a relatively lower relevancy value may be assigned to a ski lodge venue in the summer), weather, past activities of the user (e.g., the user may routinely ride the bus around lunch time), a calendar entry associated with the user (e.g., the user may have a calendar entry indicating that the user has a lunch date at a location accessible by a bus), a social network post associated with the user (e.g., the user may post on a friend's social network profile that the user is looking forward to the bus ride to visit the friend for lunch), a venue coupon (e.g., the user may have an electronic coupon for a bus ride), past user purchasing information (e.g., the user have a history of merely eating at vegetarian restaurants, and thus a relatively lower relevancy value may be assigned to a hot dog vendor venue), a user profile, past user venue visitation information (e.g., the user routinely visits a bus station around lunch), a message associated with the user, and/or any other user descriptive information to which the user has given consent to use, such as for assigning relevancy values to venues.

In an example, the first user intent inference value may be determined as a 25 out of 100 likelihood that the user has an intent to eat hot dogs based upon relevancy values of the two hotdog vendor venues (e.g., the value of 25 may be assigned based upon the user having a history of merely eating vegetarian foods, the hot dog vendor venues not being well known venues, the current time being lunch time, etc.). The second user intent inference value may be determined as a 35 out of 100 likelihood that the user has an intent to ride the bus based upon a relevancy value of the bus stop venue (e.g., the value of 35 may be assigned based upon the user previously riding the bus at lunch time, a next arrival time of a bus being over 30 minutes, merely 1 bus station being located within the first venue evaluation boundary, the user having an electronic coupon for a bus ride, etc.).

At 110, responsive to a difference between the first user intent inference value and the second user intent inference value exceeding a threshold, a first identification may be performed to identify an inferred user intent as either the first potential user intent or the second potential user intent. The larger the difference between user intent inference values, the more likely the larger user intent inference value may be indicative of the inferred user intent (e.g., if a first user intent inference value for a boating at a lake user intent is 10 out of 100 and a second user intent inference value for a dinner on the lake user intent is 80 out of 100, then a determination may be made with a relatively high degree of confidence that the user is going to dinner on the lake, and is not going boating). In an example, the inferred user intent may be identified in real-time, such as when a client device of the user indicates that the client device is currently located at the current user location (e.g., so that relevant information, such as recommendations derived from the inferred user intent, may be provided to the user in real-time).

In an example, the difference between the first user intent inference value and the second user intent inference value may not exceed the threshold. For example, the difference of 10 between the first user intent inference value of 25 and the second user intent inference value of 35 may not exceed a threshold difference of at least 30. In such a situation, additional venue information may be evaluated, such as an evaluation of venues within the second venue evaluation boundary, to identify the inferred user intent. Accordingly at 112, the difference between the first user intent inference value and the second user intent inference value may be determined as not exceeding the threshold, and thus further evaluation may be performed to identify the inferred user intent. At 114, one or more user intent inference values may be determined. In an example, a third user intent inference value for the first potential user intent may be determined based upon relevancy values of venues, of the first venue type, within the second venue evaluation boundary. For example, the third user intent inference value may be determined as a 10 out of 100 likelihood that the user has the intent to eat hot dogs based upon relevancy values of three hotdog vendor venues within the second venue evaluation boundary. A fourth user intent inference value for the second potential user intent may be determined based upon relevancy values of venues, of the second venue type, within the second venue evaluation boundary. For example, the fourth user intent inference value may be determined as a 65 out of 100 likelihood that the user has the intent to ride the bus based upon relevancy values of eight bus stops and a bus station within the second venue evaluation boundary. In an example, one or more additional potential user intents, venue types, and/or user intent inference values may be identified based upon an evaluation of the second venue evaluation boundary (e.g., a clothes shopping potential user intent may be identified based upon a clothing store venue within the second venue evaluation boundary that was not within the first venue evaluation boundary, and thus a user intent inference value may be identified for the clothes shopping potential user intent based upon a relevancy value of the clothing store venue). It will be appreciated that since the first venue evaluation boundary is within second venue evaluation boundary, the venues within the first venue evaluation boundary are generally considered when venues within the second venue evaluation boundary are considered. Similarly, venues within the first venue evaluation boundary and venues within the second venue evaluation boundary are generally considered when venues within a third venue evaluation boundary are considered, and so on.

At 116, responsive to a difference between the third user intent inference value and the fourth user intent inference value (e.g., and/or other user intent inference values of potential user intents, such as the clothes shopping potential user intent, identified within the second venue evaluation boundary) exceeding the threshold, a second identification may be performed to identify the inferred user intent as either the first potential user intent or the second potential user intent (e.g., or as other potential user intents, such as the clothes shopping potential user intent). For example, the difference of 55 between the value of 10 for the third user intent inference value and the value of 65 for the fourth user intent inference value may be indicative of the user having an intent to ride the bus, and not to eat a hot dog, with a relatively high degree of confidence. If the difference did not exceed the threshold, then a third venue evaluation boundary may be defined for evaluation to identify the inferred user intent, and then a fourth, fifth, etc. as needed.

It will be appreciated that different conditions or requirements may be set for a potential user intent to be identified as the inferred user intent. For example, a potential user intent may be identified as the inferred user intent based upon the potential user intent having the highest user intent inference value, having a user intent inference value that is within a threshold higher than a second highest user intent inference value of a second potential user intent (e.g., 2 times more than the second highest user intent inference value (e.g., 10 or more where the second highest user intent inference value is 5)), and/or having a user intent inference value within a threshold of total user intent inference values for potential user intents (e.g., at least 30% of the total user intent inference values (e.g., 30 or more where a sum of all user intent inference values for all potential user intents is 100)).

Once the inferred user intent, such as an intent to ride the bus, is determined, then various information and/or functionality may be provided to the user. In an example, a recommendation may be provided based upon the inferred user intent (e.g., a recommendation of a particular bus stop serviced by a bus that is destined for a restaurant at which the user has a scheduled lunch date). In an example, directions (e.g., to the bus stop), coupons (e.g., a bus ride discount coupon), a menu of the restaurant, a bus schedule, a website of the restaurant, a social network profile of the restaurant, a promotion of the restaurant, and/or other information may be provided based upon the inferred user intent. In an example, a suggestion of an app, available for download from an app store, may be provided based upon the inferred user intent (e.g., a bus schedule app). In an example, a determination as to whether the current user location corresponds to a residential area, a commercial area, or an industrial area may be determined based upon the inferred user intent. For example, an inferred user intent to visit an apartment may be indicative of the current user location corresponding to a residential area; an inferred user intent to purchase clothing may be indicative of the current user location corresponding to a commercial area; an inferred user intent to engage in a building activity may be indicative of the current user location corresponding to an industrial area; etc.

In this way, various information may be provided to the user based upon the inferred user intent. For example, a set of recommendations, corresponding to venues within at least one of the first venue evaluation boundary or the second venue evaluation boundary, may be identified. A first recommendation, within the set of recommendations, may be selectively provided to a client device of the user based upon the first recommendation corresponding to the inferred user intent. The first recommendation may be prioritized (e.g., presented first in a list) relative to a second recommendation, a third recommendation, etc. One or more recommendations, within the set of recommendations, that do not correspond to the inferred user intent above a threshold correspondence may not be presented to the user (e.g., recommendations other than the first recommendation). Not providing less relevant recommendations may mitigate unnecessary utilization of bandwidth and/or processing resources. At 118, the method ends.

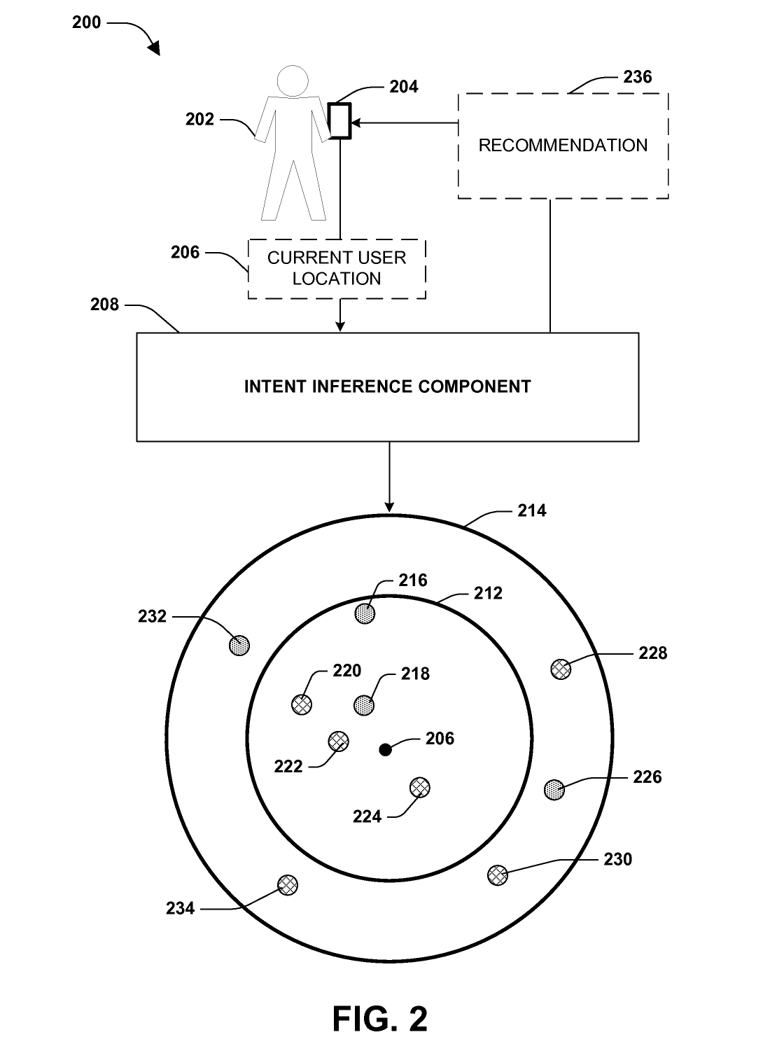

FIG. 2 illustrates an example of a system 200 for inferring user intent based upon venue boundary evaluation. The system 200 comprises an intent inference component 208 associated with a client device 204 of a user 202 (e.g., the intent inference component 208 may be hosted on the client device 204 in order to preserve privacy of user descriptive information to which the user has given consent for the intent inference component 208 to utilize in venue boundary evaluation; the intent inference component 208 may be hosted on a remote device and have a network connection to the client device 204 in order to reduce processing resource utilization on the client device 204; etc.). The intent inference component 208 may identify a current user location 206 of the user 202 (e.g., based upon GPS data from the client device 204, which may be indicative of the user 202 walking through a commercial district of a town).

The intent inference component 208 may define a first venue evaluation boundary 212 and a second venue evaluation boundary 214 based upon the current user location 206 of the user 204. It may be appreciated that any number, size, and/or shape of venue evaluation boundaries may be defined (e.g., if an evaluation of a current venue evaluation boundary does not result in an identification of an inferred user intent, then a new venue evaluation boundary may be defined for evaluation). Some venue evaluation boundaries may have a same size and/or shape while other venue evaluation boundaries may have a different size and/or shape. The intent inference component 208 may identify a first potential user intent (e.g., a restaurant dinning potential user intent) corresponding to a first venue type of venues (e.g., a first restaurant 220, a second restaurant 222, and a third restaurant 224) within the first venue evaluation boundary 212. The intent inference component 208 may identify a second potential user intent (e.g., a retail shopping potential user intent) corresponding to a second venue type of venues (e.g., a first retail store 216 and a second retail store 218) within the first venue evaluation boundary 212.

The intent inference component 208 may determine a first user intent inference value for the restaurant dinning potential user intent based upon relevancy values of the first restaurant 220, the second restaurant 222, and/or the third restaurant 224. For example, the first user intent inference value may be determined as 65 out of 100 (e.g., the user may have previously visited the first restaurant 220, the second restaurant 222 may be relatively well known, the third restaurant 224 may have relatively high user reviews, etc.). The intent inference component 208 may determine a second user intent inference value for the retail shopping potential user intent based upon relevancy values of the first retail store 216 and/or the second retail store 218. For example, the second user intent inference value may be determined as 55 out of 100 (e.g., a calendar entry may indicate that the user is to go shopping today, the user may have a coupon for the first retail store 216, the second retail store 218 may be currently open for business, etc.). Because a difference between the first user intent inference value of 65 and the second user intent inference value of 55 does not exceed a threshold difference of at least 25, for example, no inferred user intent is identified based upon an evaluation of the first venue evaluation boundary 212 (e.g., the degree of uncertainty is too high as to whether the inferred user intent should correspond to the restaurant dinning potential user intent or the retail shopping potential user intent).

Accordingly, the intent inference component 208 may evaluate the second venue evaluation boundary 214 in an attempt to identify the inferred user intent. In an example, the intent inference component 208 may determine a third user intent inference value for the restaurant dinning potential user intent based upon relevancy values of the first restaurant 220, the second restaurant 222, the third restaurant 224, a fourth restaurant 228, a fifth restaurant 230, and/or a sixth restaurant 234. For example, the third user intent inference value may be determined as 55 out of 100 (e.g., the user may have previously visited the first restaurant 220; the second restaurant 222 may be relatively well known; the third restaurant 224 may have relatively high user reviews; the fourth restaurant 228 and the fifth restaurant 230 may have relatively low user reviews; a user profile, of the user 202, may indicate that the user 202 is allergic to food at the fifth restaurant 234; etc.).

The intent inference component 208 may determine a fourth user intent inference value for the retail shopping potential user intent based upon relevancy values of the first retail store 216, the second retail store 218, a third retail shopping store 226, and/or a fourth retail shopping store 232. For example, the fourth user intent inference value may be determined as 86 out of 100 (e.g., a friend may have posted a social network post to the user's social network profile about meeting at the third retail shopping store 226; the user 202 may have printed a coupon for the third retail shopping store 226 before leaving the office; the user 202 may be social network friends with the third retail shopping store 226; etc.). Because a difference between the third user intent inference value of 55 and the fourth user intent inference value of 86 exceeds the threshold difference of at least 25, an inferred user intent of retail shopping may be determined. Various information, such as a recommendation 236 comprising promotional event information for the third retail shopping store 226 and a coupon to the fourth retail shopping store 232, may be provided to the user 202, such as through the client device 204.

In an example, the intent inference component 208 may be hosted on a remote server that is remote from the client device 204 of the user 202. The intent inference component 208 may be configured to identify the inferred user intent and provide the recommendation 236, based upon the inferred user intent, to the client device 204 to reduce utilization of processing resources on the client device 204.

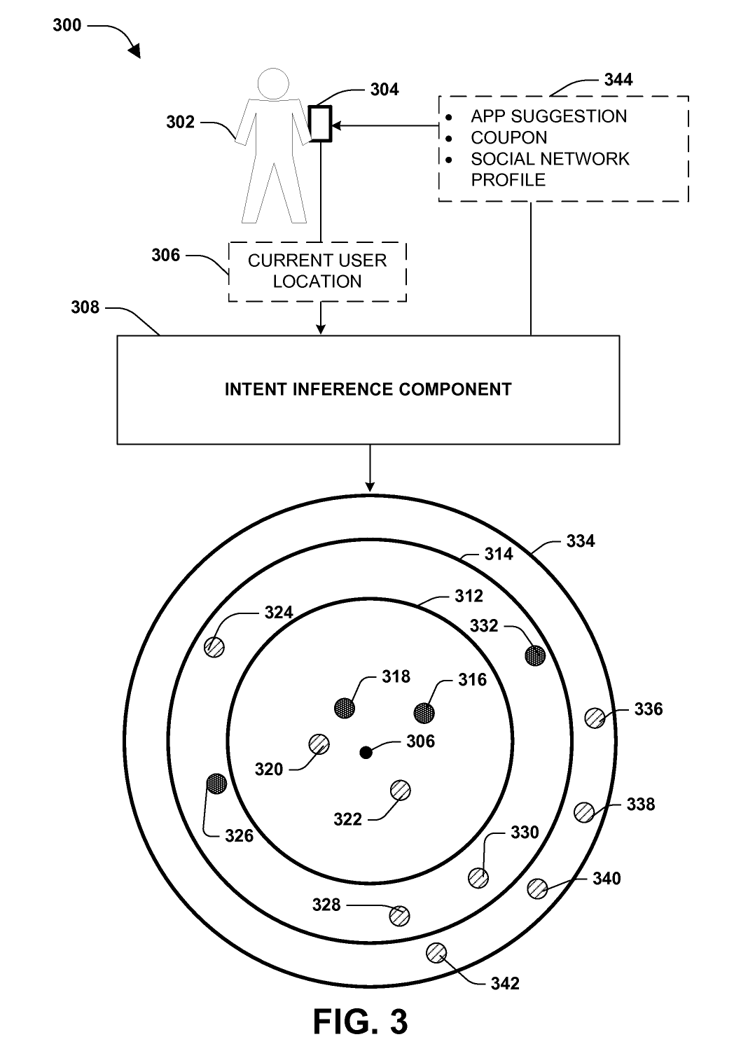

FIG. 3 illustrates an example of a system 300 for inferring user intent based upon venue boundary evaluation. The system 300 comprises an intent inference component 308 associated with a client device 304 of a user 302. The intent inference component 308 may identify a current user location 306 of the user 302 (e.g., the user 302 may be walking through a historic district of a city).

The intent inference component 308 may define a first venue evaluation boundary 312 and a second venue evaluation boundary 314 based upon the current user location 306 of the user 302. It may be appreciated that any number, size, and/or shape of venue evaluation boundaries may be defined. The intent inference component 308 may identify a first potential user intent (e.g., a historical monument tour potential user intent) corresponding to a first venue type of venues (e.g., a first historical monument 320 and a second historical monument 322) within the first venue evaluation boundary 312. The intent inference component 308 may identify a second potential user intent (e.g., a retail shopping potential user intent) corresponding to a second venue type of venues (e.g., a first retail store 316 and a second retail store 318) within the first venue evaluation boundary 312.

The intent inference component 308 may determine a first user intent inference value for the historical monument tour potential user intent based upon relevancy values of the first historical monument 320 and/or the second historical monument 322. For example, the first user intent inference value may be determined as 35 out of 100 (e.g., the first historical monument 320 may be relatively unknown and the second historical monument 322 may have relatively low user reviews). The intent inference component 308 may determine a second user intent inference value for the retail shopping potential user intent based upon relevancy values of the first retail store 316 and/or the second retail store 318. For example, the second user intent inference value may be determined as 32 out of 100 (e.g., the first retail store 316 and the second retail store 318 may be unknown tourist shopping vendors). Because a difference between the first user intent inference value of 35 and the second user intent inference value of 32 does not exceed a threshold difference of at least 20, for example, no inferred user intent is identified based upon an evaluation of the first venue evaluation boundary 312.

Accordingly, the intent inference component 308 may evaluate the second venue evaluation boundary 314 in an attempt to identify the inferred user intent. In an example, the intent inference component 308 may determine a third user intent inference value for the historical monument tour potential user intent based upon relevancy values of the first historical monument 320, the second historical monument 322, a third historical monument 324, a fourth historical monument 328, and a fifth historical monument 330. For example, the third user intent inference value may be determined as 45 out of 100 (e.g., the fourth historical monument 328 may be a relatively popular historical monument).

The intent inference component 308 may determine a fourth user intent inference value for the retail shopping potential user intent based upon relevancy values of the first retail store 316, the second retail store 318, a third retail shopping store 326, and a fourth retail shopping store 332. For example, the fourth user intent inference value may be determined as 38 out of 100 (e.g., the third retail shopping store 326 may have relatively high user reviews; the user may have a social network profile specifying an interest in clothing sold by the fourth retail shopping store 332; etc.). Because a difference between the third user intent inference value of 45 and the fourth user intent inference value of 38 does not exceed a threshold difference of at least 20, no inferred user intent is identified based upon an evaluation of the second venue evaluation boundary 314.

Accordingly, the intent inference component 308 may define a third venue evaluation boundary 334 for evaluation in order to potentially identify the inferred user intent. In an example, the intent inference component 308 may determine a fifth user intent inference value for the historical monument tour potential user intent based upon relevancy values of the first historical monument 320, the second historical monument 322, the third historical monument 324, the fourth historical monument 328, the fifth historical monument 330, a sixth historical monument 336, a seventh historical monument 338, an eighth historical monument 340, and a ninth historical monument 342. For example, the fifth user intent inference value may be determined as 70 out of 100 (e.g., the sixth historical monument 336 and the seventh historical monument 338 may be relatively popular historical monuments; the user 302 may have tagged one or more images of the eighth historical monument 340 as being a desired vacation monument to see; user reviews of the ninth historical monument 342 may indicate that just about everyone, even local residents, stop by the ninth historical monument 342).

The intent inference component 308 may determine a sixth user intent inference value for the retail shopping potential user intent based upon relevancy values of the first retail store 316, the second retail store 318, the third retail shopping store 326, and the fourth retail shopping store 332. For example, the sixth user intent inference value may be determined as 38 out of 100. Because a difference between the fifth user intent inference value of 70 and the sixth user intent inference value of 38 exceeds the threshold difference of at least 20, an inferred user intent of a historical monument tour may be determined. Various information 344, such as a historical tour app suggestion, a coupon to visit a historical monument, a social network profile of a historical monument, and/or other information, may be provided to the user 302, such as through the client device 304, based upon the inferred user intent of the historical monument tour.

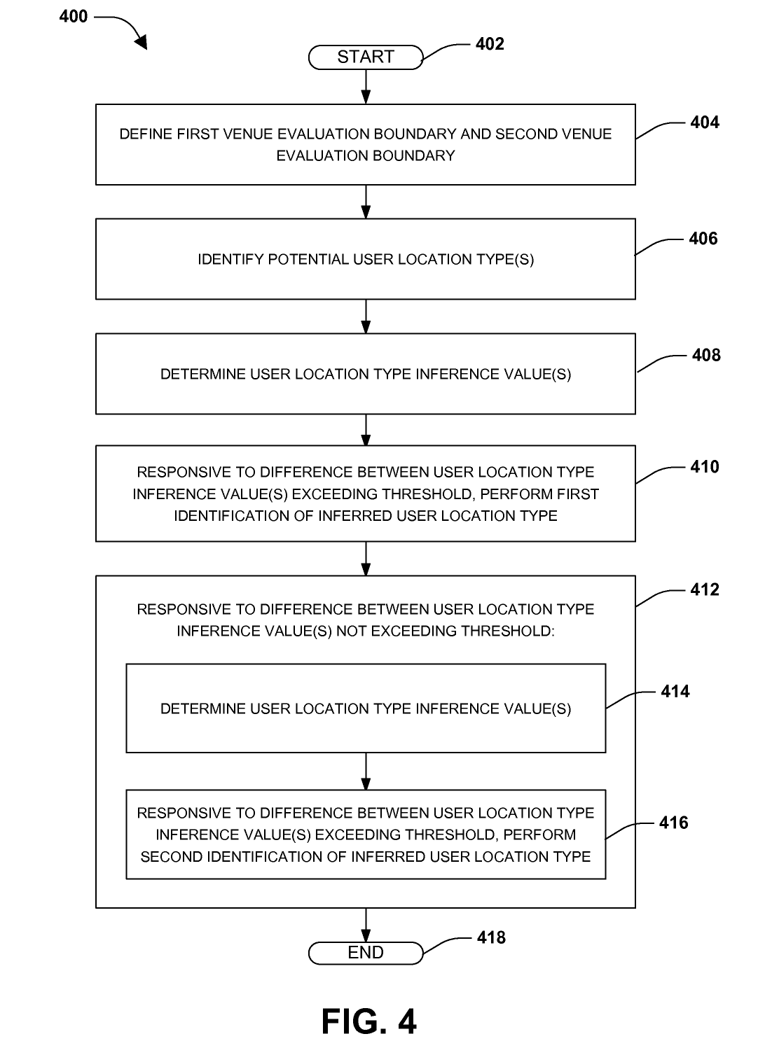

An embodiment of inferring a user location type (e.g., a commercial user location type, a residential user location type, an industrial user location type, a resort location type, a school location type, a recreational location type, and/or a variety of other location types) based upon venue boundary evaluation is illustrated by an exemplary method 400 of FIG. 4. At 402, the method starts. In an example, a user may be located at a current user location. For example, a mobile device, such as a GPS component of a mobile phone, may indicate that the user is within a city. At 404, a first venue evaluation boundary and a second venue evaluation boundary are defined based upon the current user location. At 406, one or more potential user location types, such as a first potential user location type corresponding to a first venue type of venues located within the first venue evaluation boundary (e.g., a potential commercial user location type based upon a restaurant venue and a coffee shop venue) and/or a second potential user location type corresponding to a second venue type of venues located within the first venue evaluation boundary (e.g., a potential industrial user location type based upon a warehouse venue and a plastic manufacturing venue), may be identified.

At 408, one or more user location type inference values may be determined. In an example, a first user location type inference value may be determined for the first potential user location type based upon relevancy values of venues, of the first venue type, within the first venue evaluation boundary. For example, the first user location type inference value may be determined as 38 out of 100 based upon relevancy values of the restaurant venue and the coffee shop venue. A second user location type inference value may be determined for the second potential user location type based upon relevancy values of venues, of the second venue type, within the first venue evaluation boundary. For example, the second user location type inference value may be determined as 55 out of 100 based upon relevancy values of the warehouse venue and the plastic manufacturing venue. Responsive to a difference between the first user location type inference value and the second user location type inference value exceeding a threshold, a first identification of an inferred user location type may be performed at 410 (e.g., the inferred user location type may be identified as an industrial user location type if 55 minus 38 exceeds the threshold).

Because the difference of 17 between the first user location type inference value of 38 and the second user intent inference value of 55 may not exceed the threshold (e.g., a threshold difference of at least 30), additional venue information may be evaluated, such as venues located within the second venue evaluation boundary. At 412, the difference between the first user location type inference value and the second user location type inference value may therefore be determined as not exceeding the threshold, and thus further evaluation may be performed to identify the inferred user location type. At 414, one or more user location type inference values may be determined. In an example, a third user location type inference value may be determined for the first potential user location type based upon relevancy values of venues, of the first venue type, within the second venue evaluation boundary. For example, the third user location type inference value may be determined as 39 out of 100 based upon relevancy values of the restaurant venue, the coffee shop venue, and a cafeteria venue corresponding to the potential commercial user location type. A fourth user location type inference value may be determined for the second potential user location type based upon relevancy values of venues, of the second venue type, within the second venue evaluation boundary. For example, the fourth user location type inference value may be determined as 75 out of 100 based upon relevancy values of the warehouse venue, the plastic manufacturing venue, a car manufacturing venue, and an ore refinery venue corresponding to the potential industrial user location type. Responsive to a difference between the first user location type inference value and the second user location type inference value exceeding the threshold of at least 30, a second identification of an inferred user location type may be performed. For example, the inferred user location type may be identified as the industrial user location type. At 418, the method ends.

It will be appreciated that different conditions or requirements may be set for a potential user location type to be identified as the inferred user location type. For example, a potential user location type may be identified as the inferred user location type based upon the potential user location type having the highest user location type inference value, having a user location type inference value that is within a threshold higher than a second highest user location type inference value of a second potential user location type, and/or having a user location type inference value within a threshold of total user location type inference values for potential user location types.

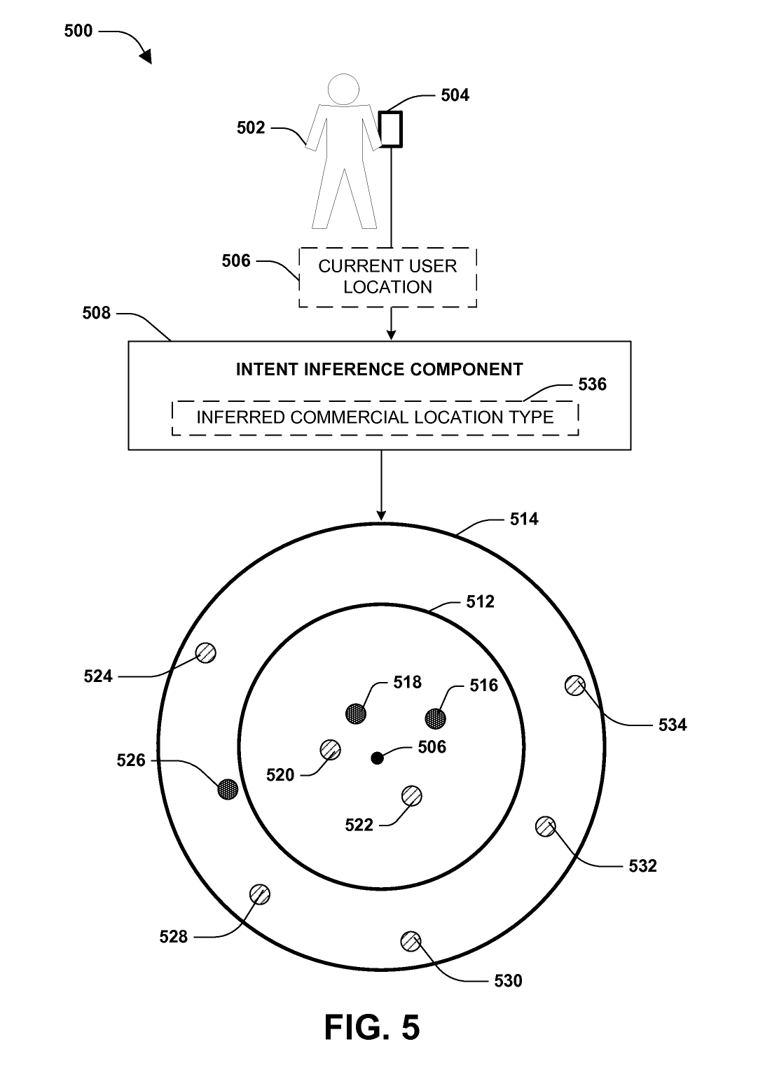

FIG. 5 illustrates an example of a system 500 for inferring user location types based upon venue boundary evaluation. The system 500 comprises an intent inference component 508 associated with a client device 504 of a user 502. The intent inference component 508 may identify a current user location 506 of the user 502 (e.g., the user 502 may be walking through a city).

The intent inference component 508 may define a first venue evaluation boundary 512 and a second venue evaluation boundary 514 based upon the current user location 506 of the user 502. It may be appreciated that any number, size, and/or shape (e.g., a square, a rectangle, a polygon, irregular, etc.) of venue evaluation boundaries may be defined. The intent inference component 508 may identify a first potential user location type (e.g., a residential location type) corresponding to a first venue type of venues (e.g., a first apartment building 520 and a first condo 522) within the first venue evaluation boundary 512. The intent inference component 508 may identify a second potential user location type (e.g., a commercial location type) corresponding to a second venue type of venues (e.g., a first retail store 516 and a second retail store 518) within the first venue evaluation boundary 512.

The intent inference component 508 may determine a first user intent inference value for the residential location type based upon relevancy values of the first apartment building 520 and the first condo 522. For example, the first user location type inference value may be determined as 55 out of 100 (e.g., apartment buildings and/or condos may contribute relatively lower relevancy scores to residential location types since such venues may also be located in commercial or other location types). The intent inference component 508 may determine a second user location type inference value for the commercial location type based upon relevancy values of the first retail store 516 and the second retail store 518. For example, the second user location type inference value may be determined as 80 out of 100. Because a difference between the first user location type inference value of 55 and the second user location type inference value of 80 do not exceed a threshold difference of at least 40, no inferred user location type is identified based upon the evaluation of the first venue evaluation boundary 512.

The intent inference component 508 may evaluate the second venue evaluation boundary 514 in an attempt to identify the inferred user location type. In an example, the intent inference component 508 may determine a third user location type inference value for the residential location type based upon relevancy values of the first apartment building 520, the first condo 522, a second condo 524, a third condo 528, a fourth condo 530, a fifth condo 532, and a sixth condo 534. For example, the third user location type inference value may be determined as 58 out of 100. The intent inference component 508 may determine a fourth user location type inference value for the commercial location type based upon relevancy values of the first retail store 516, the second retail store 518, and a shopping mall 526. For example, the fourth user intent inference value may be determined as 98 out of 100 (e.g., the shopping mall 526 may have a relatively high correlation to the commercial location type). Because a difference between the third user intent inference value of 58 and the fourth user intent inference value of 98 exceeds the threshold difference of at least 40, an inferred commercial location type 536 for the current location 506 of the user 502 may be determined.

According to an aspect of the instant disclosure, a method for inferring user intent based upon venue boundary evaluation is provided. The method includes defining a first venue evaluation boundary and a second venue evaluation boundary based upon a current user location of a user. A first potential user intent, corresponding to a first venue type of venues located within the first venue evaluation boundary, is identified. A second potential user intent, corresponding to a second venue type of venues located within the first venue evaluation boundary, is identified. A first user intent inference value is determined for the first potential user intent based upon relevancy values of venues, of the first venue type, within the first venue evaluation boundary. A second user intent inference value is determined for the second potential user intent based upon relevancy values of venues, of the second venue type, within the first venue evaluation boundary. Responsive to a difference between the first user intent inference value and the second user intent inference value exceeding a threshold, a first identification of an inferred user intent as either the first potential user intent or the second potential user intent is performed. Responsive to the difference between the first user intent inference value and the second user intent inference value not exceeding the threshold, a third user intent inference value for the first potential user intent is determined based upon relevancy values of venues, of the first venue type, within the second venue evaluation boundary. A fourth user intent inference value, for the second potential user intent, is determined based upon relevancy values of venues, of the second venue type, within the second venue evaluation boundary. Responsive to a difference between the third user intent inference value and the fourth user intent inference value exceeding the threshold, a second identification of the inferred user intent as either the first potential user intent or the second potential user intent is performed.

According to an aspect of the instant disclosure, a system for inferring user intent based upon venue boundary evaluation is provided. The system includes an intent inference component. The intent inference component is configured to define a first venue evaluation boundary and a second venue evaluation boundary based upon a current user location of a user. The intent inference component is configured to identify a first potential user intent corresponding to a first venue type of venues located within the first venue evaluation boundary. The intent inference component is configured to identify a second potential user intent corresponding to a second venue type of venues located within the first venue evaluation boundary. The intent inference component is configured to determine a first user intent inference value for the first potential user intent based upon relevancy values of venues, of the first venue type, within the first venue evaluation boundary. The intent inference component is configured to determine a second user intent inference value for the second potential user intent based upon relevancy values of venues, of the second venue type, within the first venue evaluation boundary. Responsive to a difference between the first user intent inference value and the second user intent inference value exceeding a threshold, the intent inference component is configured to perform a first identification of an inferred user intent as either the first potential user intent or the second potential user intent. Responsive to the difference between the first user intent inference value and the second user intent inference value not exceeding the threshold, the intent inference component is configured to determine a third user intent inference value for the first potential user intent based upon relevancy values of venues, of the first venue type, within the second venue evaluation boundary. The intent inference component is configured to determine a fourth user intent inference value for the second potential user intent based upon relevancy values of venues, of the second venue type, within the second venue evaluation boundary. Responsive to a difference between the third user intent inference value and the fourth user intent inference value exceeding the threshold, the intent inference component is configured to perform a second identification of the inferred user intent as either the first potential user intent or the second potential user intent.

According to an aspect of the instant disclosure, a computer readable medium comprising instructions which when executed perform a method for inferring a user location type based upon venue boundary evaluation is provided. The method includes defining a first venue evaluation boundary and a second venue evaluation boundary based upon a current user location of a user. A first potential user location type, corresponding to a first venue type of venues located within the first venue evaluation boundary, is identified. A second potential user location type, corresponding to a second venue type of venues located within the first venue evaluation boundary, is identified. A first user location type inference value is determined for the first potential user location type based upon relevancy values of venues, of the first venue type, within the first venue evaluation boundary. A second user location type inference value is determined for the second potential user location type based upon relevancy values of venues, of the second venue type, within the first venue evaluation boundary. Responsive to a difference between the first user location type inference value and the second user location type inference value exceeding a threshold, a first identification of an inferred user location type as either the first potential user location type or the second potential user location type is performed. Responsive to the difference between the first user location type inference value and the second user location type inference value not exceeding the threshold, a third user location type inference value for the first potential user location type is determined based upon relevancy values of venues, of the first venue type, within the second venue evaluation boundary. A fourth user location type inference value, for the second potential user location type, is determined based upon relevancy values of venues, of the second venue type, within the second venue evaluation boundary. Responsive to a difference between the third user location type inference value and the fourth user location type inference value exceeding the threshold, a second identification of the inferred user location type as either the first potential user location type or the second potential user location type is performed.

According to an aspect of the instant disclosure, a means for inferring user intent based upon venue boundary evaluation is provided. A first venue evaluation boundary and a second venue evaluation boundary are defined based upon a current user location of a user, by the means for inferring user intent. A first potential user intent, corresponding to a first venue type of venues located within the first venue evaluation boundary, is identified, by the means for inferring user intent. A second potential user intent, corresponding to a second venue type of venues located within the first venue evaluation boundary, is identified, by the means for inferring user intent. A first user intent inference value is determined for the first potential user intent based upon relevancy values of venues, of the first venue type, within the first venue evaluation boundary, by the means for inferring user intent. A second user intent inference value is determined for the second potential user intent based upon relevancy values of venues, of the second venue type, within the first venue evaluation boundary, by the means for inferring user intent. Responsive to a difference between the first user intent inference value and the second user intent inference value exceeding a threshold, a first identification of an inferred user intent as either the first potential user intent or the second potential user intent is performed, by the means for inferring user intent. Responsive to the difference between the first user intent inference value and the second user intent inference value not exceeding the threshold, a third user intent inference value for the first potential user intent is determined based upon relevancy values of venues, of the first venue type, within the second venue evaluation boundary, by the means for inferring user intent. A fourth user intent inference value, for the second potential user intent, is determined based upon relevancy values of venues, of the second venue type, within the second venue evaluation boundary, by the means for inferring user intent. Responsive to a difference between the third user intent inference value and the fourth user intent inference value exceeding the threshold, a second identification of the inferred user intent as either the first potential user intent or the second potential user intent is performed, by the means for inferring user intent.

According to an aspect of the instant disclosure, a means for inferring a user location type based upon venue boundary evaluation is provided. A first venue evaluation boundary and a second venue evaluation boundary are defined based upon a current user location of a user, by the means for inferring a user location type. A first potential user location type, corresponding to a first venue type of venues located within the first venue evaluation boundary, is identified, by the means for inferring a user location type. A second potential user location type, corresponding to a second venue type of venues located within the first venue evaluation boundary, is identified, by the means for inferring a user location type. A first user location type inference value is determined for the first potential user location type based upon relevancy values of venues, of the first venue type, within the first venue evaluation boundary, by the means for inferring a user location type. A second user location type inference value is determined for the second potential user location type based upon relevancy values of venues, of the second venue type, within the first venue evaluation boundary, by the means for inferring a user location type. Responsive to a difference between the first user location type inference value and the second user location type inference value exceeding a threshold, a first identification of an inferred user location type as either the first potential user location type or the second potential user location type is performed, by the means for inferring a user location type. Responsive to the difference between the first user location type inference value and the second user location type inference value not exceeding the threshold, a third user location type inference value for the first potential user location type is determined based upon relevancy values of venues, of the first venue type, within the second venue evaluation boundary, by the means for inferring a user location type. A fourth user location type inference value, for the second potential user location type, is determined based upon relevancy values of venues, of the second venue type, within the second venue evaluation boundary, by the means for inferring a user location type. Responsive to a difference between the third user location type inference value and the fourth user location type inference value exceeding the threshold, a second identification of the inferred user location type as either the first potential user location type or the second potential user location type is performed, by the means for inferring a user location type.

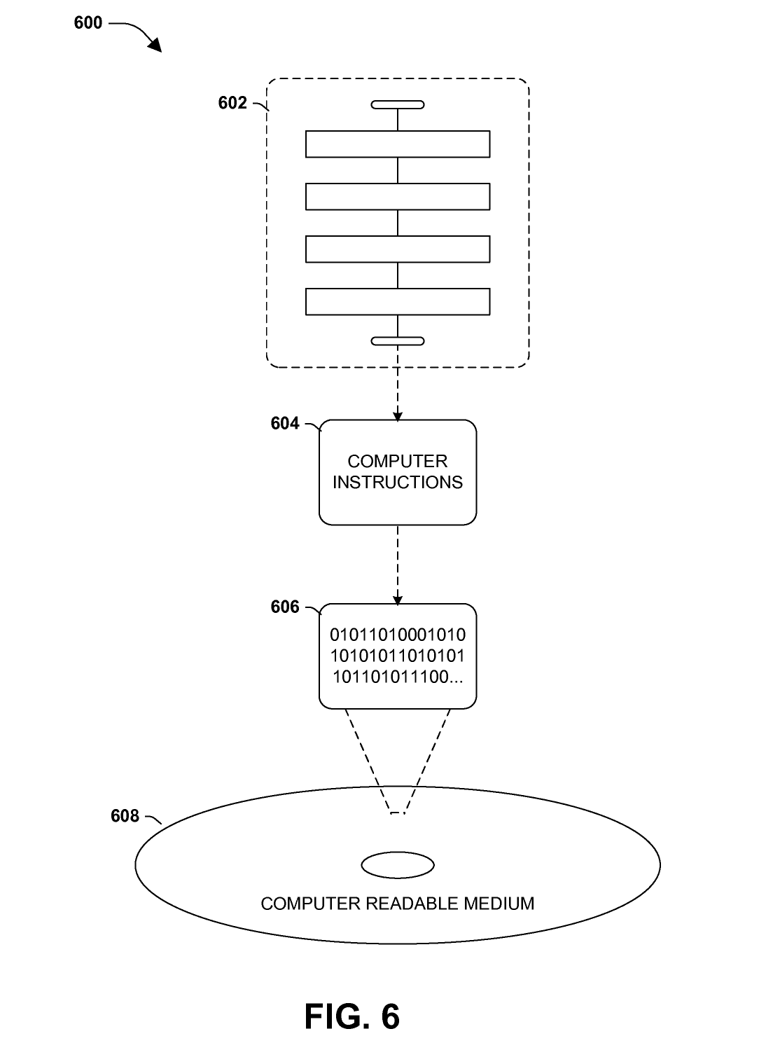

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1 and/or at least some of the exemplary method 400 of FIG. 4, for example. In some embodiments, the processor-executable instructions 604 are configured to implement a system, such as at least some of the exemplary system 200 of FIG. 2, at least some of the exemplary system 300 of FIG. 3, and/or at least some of the exemplary system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

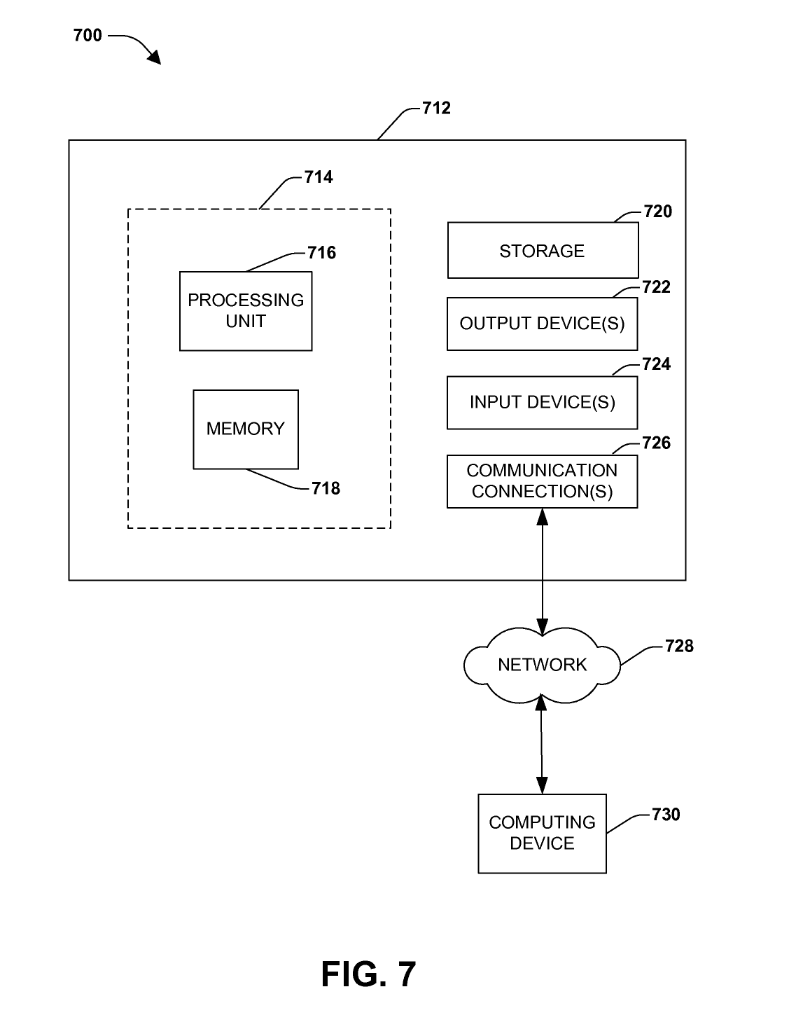

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for inferring user intent based upon venue boundary evaluation, comprising:
defining a first venue evaluation boundary and a second venue evaluation boundary based upon a current user location of a user;
identifying a first potential user intent corresponding to a first venue type of venues located within the first venue evaluation boundary;
identifying a second potential user intent corresponding to a second venue type of venues located within the first venue evaluation boundary;
determining a first user intent inference value for the first potential user intent based upon relevancy values of venues, of the first venue type, within the first venue evaluation boundary;
determining a second user intent inference value for the second potential user intent based upon relevancy values of venues, of the second venue type, within the first venue evaluation boundary;
responsive to a difference between the first user intent inference value and the second user intent inference value exceeding a threshold, performing a first identification of an inferred user intent as either the first potential user intent or the second potential user intent; and
responsive to the difference between the first user intent inference value and the second user intent inference value not exceeding the threshold:
determining a third user intent inference value for the first potential user intent based upon relevancy values of venues, of the first venue type, within the second venue evaluation boundary;
determining a fourth user intent inference value for the second potential user intent based upon relevancy values of venues, of the second venue type, within the second venue evaluation boundary; and
responsive to a difference between the third user intent inference value and the fourth user intent inference value exceeding the threshold, performing a second identification of the inferred user intent as either the first potential user intent or the second potential user intent.

2. The method of claim 1, at least one of the performing a first identification or the performing a second identification comprising:
identifying the inferred user intent in real-time based upon a client device of the user indicating that the client device is currently located at the current user location.

3. The method of claim 1, the defining a first venue evaluation boundary comprising:
specifying a first size for the first evaluation boundary based upon at least one of the first venue type or the second venue type.

4. The method of claim 1, comprising:
determining a relevancy value of a venue based upon at least one of a name of the venue, a type of the venue, a distance between the venue and the current user location, a popularity of the venue, a review of the venue, operating hours of the venue, or descriptive information of the venue.

5. The method of claim 1, comprising:
determining a relevancy value of a venue based upon at least one of a current time, a current date, a current season, weather, past activity of the user, a calendar entry associated with the user, a social network post associated with the user, a venue coupon, past user purchasing information, a user profile, past user venue visitation information, a message associated with the user, or user descriptive information.

6. The method of claim 1, comprising:
identifying a third potential user intent corresponding to a third venue type of venues located within the second venue evaluation boundary;
determining a fifth user intent inference value for the third potential user intent based upon relevancy values of venues, of the third venue type, within the second venue evaluation boundary; and
evaluating the fifth user intent inference value to determine whether the third potential user intent is to be identified as the inferred user intent.

7. The method of claim 1, comprising:
identifying a set of recommendations corresponding to venues within at least one of the first venue evaluation boundary or the second venue evaluation boundary; and
selectively providing a recommendation, within the set of recommendations, to a client device of the user based upon the recommendation corresponding to the inferred user intent, the selectively providing comprising refraining from providing a second recommendation, within the set of recommendations, that does not correspond to the inferred user intent above a threshold correspondence to reduce network bandwidth utilization.

8. The method of claim 1, the second venue evaluation boundary comprising the first venue evaluation boundary and comprising an area not comprised within the first venue evaluation boundary.

9. The method of claim 1, comprising:
providing a recommendation based upon the inferred user intent, the recommendation corresponding to a venue within at least one of the first venue evaluation boundary or the second venue evaluation boundary.

10. The method of claim 1, comprising:
determining that the current user location corresponds to a residential area based upon the inferred user intent.

11. The method of claim 1, comprising:
determining that the current user location corresponds to a commercial area based upon the inferred user intent.

12. The method of claim 1, comprising:
determining that the current user location corresponds to an industrial area based upon the inferred user intent.

13. The method of claim 1, comprising:
providing at least one of directions, a coupon, a menu, a venue website, a venue social network profile, or a venue promotion based upon the inferred user intent.

14. The method of claim 1, comprising:
providing a suggestion of an app, available for download from an app store, based upon the inferred user intent.

15. A system for inferring user intent based upon venue boundary evaluation, comprising:
an intent inference component configured to:
define a first venue evaluation boundary and a second venue evaluation boundary based upon a current user location of a user;
identify a first potential user intent corresponding to a first venue type of venues located within the first venue evaluation boundary;
identify a second potential user intent corresponding to a second venue type of venues located within the first venue evaluation boundary;
determine a first user intent inference value for the first potential user intent based upon relevancy values of venues, of the first venue type, within the first venue evaluation boundary;
determine a second user intent inference value for the second potential user intent based upon relevancy values of venues, of the second venue type, within the first venue evaluation boundary;
responsive to a difference between the first user intent inference value and the second user intent inference value exceeding a threshold, perform a first identification of an inferred user intent as either the first potential user intent or the second potential user intent; and
responsive to the difference between the first user intent inference value and the second user intent inference value not exceeding the threshold:
determine a third user intent inference value for the first potential user intent based upon relevancy values of venues, of the first venue type, within the second venue evaluation boundary;
determine a fourth user intent inference value for the second potential user intent based upon relevancy values of venues, of the second venue type, within the second venue evaluation boundary; and
responsive to a difference between the third user intent inference value and the fourth user intent inference value exceeding the threshold, perform a second identification of the inferred user intent as either the first potential user intent or the second potential user intent.

16. The system of claim 16, the intent inference component configured to:
identify the inferred user intent in real-time based upon a client device of the user indicating that the client device is at the current user location.

17. The system of claim 16, the intent inference component configured to:
specify a first size for the first evaluation boundary based upon at least one of the first venue type or the second venue type.

18. The system of claim 16, an intent inference component configured to:
provide a recommendation based upon the inferred user intent.

19. The system of claim 16, the intent inference component hosted on a remote server that is remote from a client device of the user, and the intent inference component configured to identify the inferred user intent and provide a recommendation, based upon the inferred user intent, to the client device to reduce utilization of processing resources on the client device.

20. A computer readable medium comprising instructions which when executed perform a method for inferring a user location type based upon venue boundary evaluation, comprising:
defining a first venue evaluation boundary and a second venue evaluation boundary based upon a current user location of a user;
identifying a first potential user location type corresponding to a first venue type of venues located within the first venue evaluation boundary;
identifying a second potential user location type corresponding to a second venue type of venues located within the first venue evaluation boundary;
determining a first user location type inference value for the first potential user location type based upon relevancy values of venues, of the first venue type, within the first venue evaluation boundary;
determining a second user location type inference value for the second potential user location type based upon relevancy values of venues, of the second venue type, within the first venue evaluation boundary;
responsive to a difference between the first user location type inference value and the second user location type inference value exceeding a threshold, performing a first identification of an inferred user location type as either the first potential user location type or the second potential user location type; and
responsive to the difference between the first user location type inference value and the second user location type inference value not exceeding the threshold:
determining a third user location type inference value for the first potential user location type based upon relevancy values of venues, of the first venue type, within the second venue evaluation boundary;
determining a fourth user location type inference value for the second potential user location type based upon relevancy values of venues, of the second venue type, within the second venue evaluation boundary; and
responsive to a difference between the third user location type inference value and the fourth user location type inference value exceeding the threshold, performing a second identification of the inferred user location type as either the first potential user location type or the second potential user location type.

21. The computer readable medium of claim 20, the inferred user location type corresponding to at least one of a residential location type, a commercial location type, an industrial location type, a resort location type, a school location type, or a recreational location type.

22. The computer readable medium of claim 19, comprising:
identifying a set of recommendations corresponding to venues within at least one of the first venue evaluation boundary or the second venue evaluation boundary; and
selectively providing a recommendation, within the set of recommendations, to a client device of the user based upon the recommendation corresponding to the inferred user intent, the selectively providing comprising refraining from providing a second recommendation, within the set of recommendations, that does not correspond to the inferred user intent above a threshold correspondence to reduce network bandwidth utilization.
